(19) United States
(12) Patent Application Publication
(10) Pub. No.: US 2012/0018358 A1
(43) Pub. Date: Jan. 26, 2012

(54) FILTER APPARATUS

(76) Inventors: Norbert Sann, Riegelsberg (DE); Michael Sakraschinsky, St. Ingbert (DE); Stefan Hennes, Hangard (DE)

(21) Appl. No.: 13/138,816

(22) PCT Filed: Mar. 10, 2010
(86) PCT No.: PCT/EP2010/001481

§ 371 Date: Oct. 3, 2011

(30) Foreign Application Priority Data
Apr. 15, 2009 (DE) 102009017093.6

(51) Int. Cl. B01D 29/92; B01D 29/60; B01D 27/00

(52) U.S. Cl. 210/109

(57) ABSTRACT

A filter apparatus, provided for installation in a fluid storage tank, having at least one preferably replaceable filter element (11), through which a fluid can flow from the outside to an inner hollow filter chamber (19), forming the clean side, and which is surrounded by a housing wall (1) which forms a fluid chamber (15), into which the cleaned fluid from the inner hollow filter chamber (19) can flow, the housing wall having at least one wall opening (31) which forms a fluid passage located within the region of the variable fluid level in the storage tank. Said filter apparatus is characterized in that a control device (39, 41, 43) is provided which can be actuated as a function of the fluid level the storage tank and brings the fluid passage of the at least one wall opening (31) close to the position of the surface of the fluid in the storage tank.

The invention relates to a filter apparatus designed for installation in a fluid storage tank, having at least one preferably replaceable filter element through which a fluid can flow from the outside to an inner filter cavity which forms the clean side and which is surrounded by a housing wall which forms a fluid chamber into which the cleaned fluid from the inner filter cavity can flow, the housing wall having at least one wall opening which forms a fluid passage located within the region of the variable fluid level in the storage tank.

Solutions of this type are also referred to as in-tank solutions in the technical jargon. Such apparatus are primarily used in devices and equipment which are equipped with hydraulic operating circuits; this is especially the case in mobile machinery, for example, excavators, wheeled or telescopic loaders which are extensively provided with working hydraulics, for example, in the form of hydraulic cylinders which can be supplied and actuated by means of pumps. In operation, the filter element forms the return filter from whose clean side the cleaned hydraulic oil travels directly into the hydraulic tank from which the hydraulic oil is again directly intaken by the pertinent hydraulic pump.

In passage through the operating circuit, typically air is introduced into the hydraulic oil. This air degrades the behavior of the hydraulic system; this is referred to, for example, as the hydraulics becoming “soft.” Moreover, there is the risk of cavitation of the hydraulic pump when air is intaken. In this respect, it is preferable that a certain degassing takes place during the residence time of the hydraulic oil in the tank by the air rising in the tank and escaping.

Especially in mobile machinery in which complex system components must be arranged in a narrow space, it is necessary that the components be built in a design which saves as much space as possible. This means that the pertinent hydraulic tank must be designed to have a small volume. When using smaller tanks, however, the hydraulic oil is circulated more quickly and more often with a correspondingly shortened residence time in the tank. This in turn leads to the air in the hydraulic oil no longer being able to adequately escape because the air hardly has the opportunity to rise in the tank and escape.

In light of this problem, the object of the invention is to provide a filter apparatus which enables effective degassing even for a small-volume design of the pertinent storage tank.

This object is achieved according to the invention by a filter apparatus which has the features of claim 1 in its entirety.

According to the characterizing part of claim 1, in a filter apparatus of the initially mentioned type, there is a control device which can be actuated as a function of the fluid level in the storage tank and which brings the fluid passage through the at least one wall opening nearer the location of the fluid surface in the storage tank. Thus an outflow of the fluid near the surface is dictated, the location of the outflow region tracking the changes of the fluid level. In that—in spite of fluctuations of the fluid level—the cleaned fluid emerges from the filter apparatus near the surface in this way, separation and escape of gas bubbles from the hydraulic oil are substantially promoted. Due to this location of the outflow region, mixing with the hydraulic oil contained in the tank is also less. The extensive degassing of the hydraulic oil which is achieved improves the operating behavior of hydraulic operating circuits in several respects, for instance, by reducing the generation of noise, preventing damage such as cavitation, reduced temperature increase, avoiding dynamic operating problems, and avoiding premature oil aging or undesirable viscosity changes.

In especially advantageous exemplary embodiments, the control device has a float which converts fluctuations of the fluid level into positioning movements for adjusting the location of the opening cross section of the fluid passage through the at least one wall opening. The float actuation enables reliable control with an extremely simple construction.

In advantageous exemplary embodiments, the arrangement can be made such that the housing wall exhibiting the at least one wall opening is part of a cup-like filter housing which has a closed cup bottom which is exposed to the fluid flow emerging from the inner filter cavity of the filter element, the cup bottom having a flow deflection device which acts as a diffusor.

In exemplary embodiments with a filter housing which is made circularly cylindrical at least in the region of the cup bottom and the cleaned fluid emerging from the inner filter cavity essentially coaxially to the axis of the filter housing in the direction to the cup bottom, the flow deflection device acting as a diffusor can be formed by a curvature of the cup bottom.

To optimize the flow conditions, the arrangement can be made such that the curvature is formed by part of the inside wall of a torus so that the axial flow striking the bottom is spread into a radial flow which continues along the housing wall in a rising axial flow. In this way, the fluid emerges from the pertinent fluid passages of the filter housing in the form of an essentially damped flow without spraying or foaming occurring in the tank, even at high working pressure and/or for large amounts of fluid.

With respect to the execution of the control device, the arrangement can preferably be made such that the control device has a sleeve which is provided with a buoyancy body which is used as a float, which forms a type of valve spool, and which is supported to be able to move axially on the housing wall which has the at least one wall opening and in the sleeve wall has at least one opening which can be adjusted relative to the fluid passage to control the opening cross section of the fluid passage through the at least one wall opening by the axial movements which are caused by the float.

In order to promote low-resistance outflow with larger amounts of fluid, there can be several wall openings distributed peripherally in the housing wall as fluid passages.

Accordingly, there can be several openings which are arranged distributed peripherally in the sleeve wall which acts as a valve spool.

The invention is detailed below using one exemplary embodiment shown in the drawings.

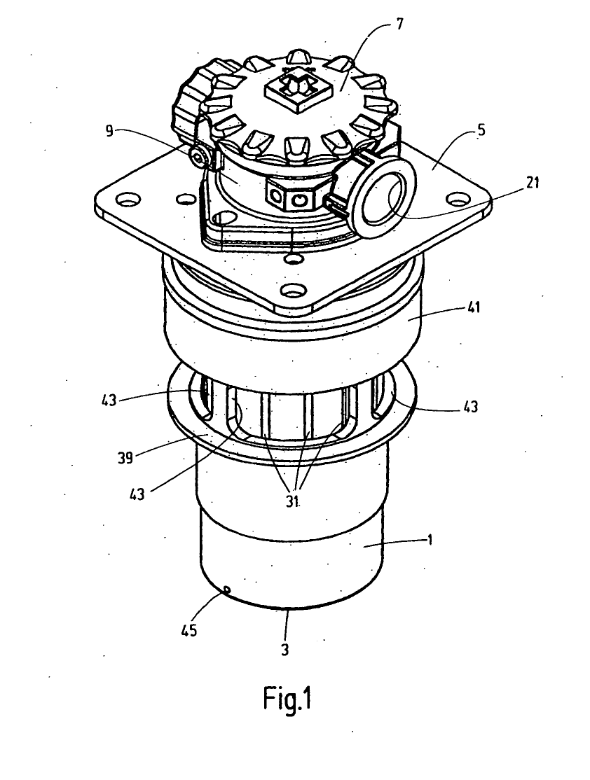

FIG. 1 shows a perspective oblique view of one exemplary embodiment of the apparatus according to the invention which is drawn roughly to the scale of a practical embodiment;

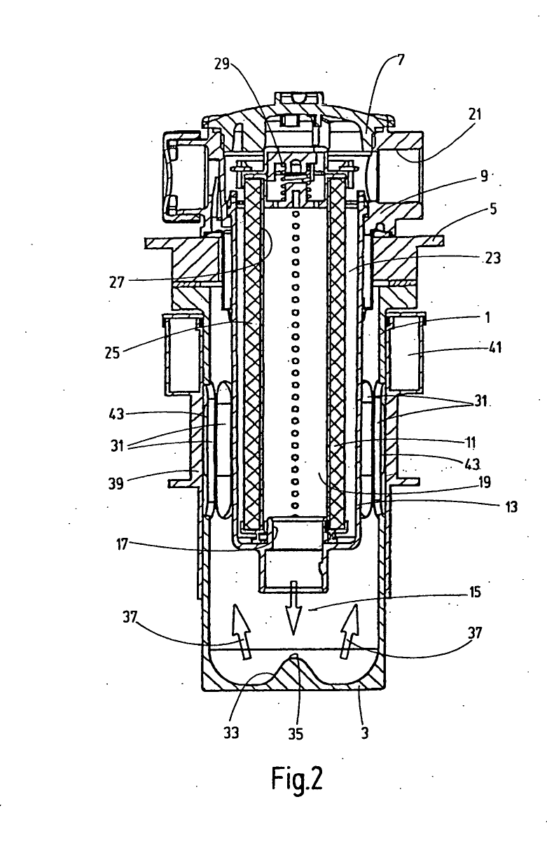

FIG. 2 shows a longitudinal section of the exemplary embodiment from FIG. 1, a control device provided with a float being shown in a raised end position, and

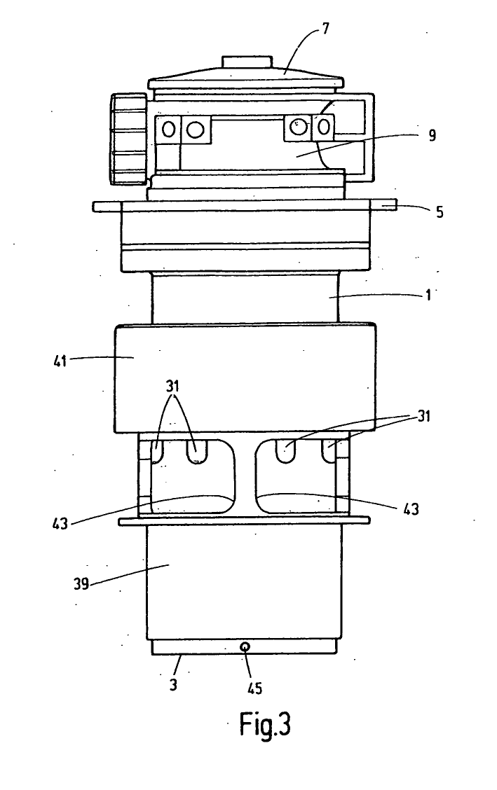

FIG. 3 shows a side view of the exemplary embodiment, the control device being shown in the position which is conversely lowered.

The invention is detailed below using a so-called in-tank filter apparatus in which the apparatus shown in the figures is installed in a hydraulic tank which is not shown.

The filter apparatus has a filter housing 1 in the form of a largely circularly cylindrical cup which is closed on the bottom side by a cup bottom 3 which is molded on in one piece. On the top end of the filter housing 1, there is a flange plate 5 for installation of the apparatus in a tank opening in the upper tank wall of a hydraulic tank which is not shown. On the flange plate 5 is a housing head 9 which forms the upper termination of the filter housing 1 with a cover 7 which can be removed to replace a filter element 11. To form a type of filter cartridge, the filter element 11 has an inner housing 13 which is supported on its top end in the housing head 9 and extends coaxially in the housing 1 in the direction to the cup bottom 3, but to form a flow space 15 ends at a greater distance from the cup bottom 3. On this lower end of the inner housing 13, there is an outflow opening 17 through which cleaned fluid flows out of the inner filter cavity 19 of the filter element 11 with an axial flow direction toward the cup bottom 3 in the operation of the filter apparatus. The top end of the inner housing 13 is open toward the housing head 9 in which, in the manner conventional in these apparatus, there are fluid guides, a fluid connection 21 being provided for supply of return hydraulic oil which travels to an outer filter cavity 23 which forms the dirty side and which surrounds the outside of a filter medium 25 within the inner housing 13. This filter medium is mounted, for example, in the form of a pleated filter mat on a fluid-permeable support pipe 27 which surrounds the inner filter cavity 19 which is connected to the outlet opening 17 with the formation of a seal. In operation, the returning fluid flows from the outer filter cavity 23 through the filter medium 25 to the inner filter cavity 19 from which it flows in an axial flow through the outflow opening 17 to the cup bottom 3. On the top end of the filter element 11, in the manner conventional in these apparatus, there is a bypass valve arrangement 29 which, as a function of a corresponding difference pressure between the outer filter cavity 23 and the inner filter cavity 19, clears a fluid path between these cavities.

The cleaned fluid which is flowing out of the inner filter cavity 19 through the outflow opening 17 in the axial direction, in operation on its downward oriented flow path does not reach the base of the storage tank, because the filter housing 1 has a closed bottom 3 which borders a flow space 15 at a distance from the outflow opening 17. For emergence of the cleaned fluid from the flow space 15, wall openings 31 are formed in the wall of the filter housing 1 as fluid passages. These wall openings 31 are arranged offset upward relative to the cup bottom 3, and thus especially relative to the base region of the storage tank, into a region within which the fluid level in the storage tank changes during operation. While ordinarily the cleaned fluid flows out of the filter cavity of the filter element axially downward toward the base of the tank, in the invention a flow deflection on the closed cup bottom 3 is formed so that a flow, which is directed upward and which flows out of the wall openings 31 which are offset upward, is formed from the axial flow which is directed downward within the flow space 15.

The flow deflection device formed on the cup bottom 3 is designed as a diffusor. For this purpose, the cup bottom 3 has a curvature 33 which corresponds to the inner wall of part of a torus so that the axial flow out of the outflow opening 17 strikes an elevation 35 on which the axial flow is spread into a radial flow which, as indicated with flow arrows 37 in FIG. 2, continues along the inner wall of the filter housing 1 in a rising axial flow in the direction to the wall openings 31.

The invention provides a control device which matches the opening cross section of the fluid passages formed by the wall openings 31 to the current level state in the storage tank. For this purpose, on the outside of the filter housing 1 a sleeve 39, which forms a type of valve spool, is supported to be able to move axially, and on whose top end a buoyancy body 41 in the form of an air receiver which annularly surrounds the filter housing 1 is located. The buoyancy body 41 is used as a float which imparts positioning movements to the sleeve 39 according to the changes of the fluid level. The sleeve 39 has window-like openings 43 for the control function. The positional relation between the float, which is formed by the buoyancy body 41 and which is always in the surface region of the fluid level in operation, and the openings 43 as well as the wall openings 31, always ensures in operation that the fluid passage formed on the wall openings 31 of the filter housing 1 is near the fluid surface. In other words, it is therefore ensured that the cleaned fluid flow can rise within the filter housing 1 so far that the fluid emergence into the tank is limited to a region slightly below the surface of the fluid level. While therefore the flow deflection on the cup bottom 3 results in that the fluid emergence into the tank interior is offset upwardly in the direction to the fluid surface, it is at the same time ensured that even when the fluid level drops, there is no danger that fluid can emerge from the wall openings above the current fluid level, so the danger is avoided that spraying or foaming could occur in the tank due to surface fluid emergence. The combination float control/diffusor in each instance optimizes the flow behavior, degassing of the fluid being promoted by the outflow near the surface.

There is a stop pin 45 on the cup bottom 3 of the filter housing 1 to limit the bottom end position of the sleeve 39 shown in FIG. 3.

1. A filter apparatus designed for installation in a fluid storage tank, having at least one preferably replaceable filter element (11) through which a fluid can flow from the outside to an inner filter cavity (19) which forms the clean side and which is surrounded by a housing wall (1) which forms a fluid chamber (15) into which the cleaned fluid from the inner filter cavity (19) can flow, the housing wall having at least one wall opening (31) which forms a fluid passage located within the region of the variable fluid level in the storage tank, characterized in that there is a control device (39, 41, 43) which can be actuated as a function of the fluid level in the storage tank and which brings the fluid passage through the at least one wall opening (31) nearer the location of the fluid surface in the storage tank.

2. The filter apparatus according to claim 1, characterized in that the control device (39, 41, 43) has a float (41) which converts fluctuations of the fluid level into positioning movements for adjusting the location of the opening cross section of the fluid passage through the at least one wall opening (31).

3. The filter apparatus according to claim 2, characterized in that the housing wall which has the at least one wall opening (31) is part of a cup-like filter housing (1) which has a closed cup bottom (3) which is exposed to the fluid flow emerging from the inner filter cavity (19) of the filter element (11), and that the cup bottom (3) has a flow deflection device (33, 35) which acts as a diffusor.

4. The filter apparatus according to claim 3, characterized in that the filter housing (1) is made circularly cylindrical at least in the region of the cup bottom (3), that the cleaned fluid emerges from the inner filter cavity (19) essentially coaxially to the axis of the filter housing (1) in the direction to the cup bottom (3), and that the cup bottom has a curvature (33, 35) which forms the deflection device.

5. The filter apparatus according to claim 4, characterized in that the curvature is formed by part of the inside wall of a torus (33) so that the axial flow striking the bottom (3) is spread into a radial flow which continues along the housing wall (1) in a rising axial flow.

6. The filter apparatus according to claim 2, characterized in that the control device (39, 41, 43) has a sleeve (39) which is provided with a buoyancy body (41) which is used as float, which forms a type of valve spool, and which is supported to be able to move axially on the housing wall (1) which has the at least one wall opening (31) and in the sleeve wall has at least one opening (43) which can be adjusted relative to the fluid passage to control the opening cross section of the fluid passage through the at least one wall opening (31) by the axial movements which are caused by the float.

7. The filter apparatus according to claim 6, characterized in that the at least one wall opening (31) which forms the fluid passage extends over the entire region of change of the fluid level.

8. The filter apparatus according to claim 6, characterized in that there are several wall openings (31) distributed peripherally in the housing wall (1) as fluid passages.

9. The filter apparatus according to claim 6, characterized in that there are several openings (43) distributed peripherally in the sleeve wall.

10. The filter apparatus according to claim 6, characterized in that on the housing wall (1) there is a stop device (45) which limits the end positions of the axial movement of the sleeve (39).
